(19) United States
(12) Patent Application Publication
(10) Pub. No.: US 2024/0161594 A1
(43) Pub. Date: May 16, 2024

(54) INFORMATION NOTIFICATION METHOD, INFORMATION NOTIFICATION DEVICE, AND NON-TRANSITORY COMPUTER READABLE RECORDING MEDIUM STORING INFORMATION NOTIFICATION PROGRAM

(71) Applicant: Panasonic Intellectual Property Corporation of America, Torrance, CA (US)

(72) Inventors: Kotaro SAKATA, Osaka (JP); Keiichi TOIYAMA, Osaka (JP); Kenta MURAKAMI, Osaka (JP); Takamichi MATSUSAKO, Tokyo (JP); Megumi MIZOGUCHI, Kyoto (JP)

(73) Assignee: Panasonic Intellectual Property Corporation of America, Torrance, CA (US)

(21) Appl. No.: 18/422,879

(22) Filed: Jan. 25, 2024

Related U.S. Application Data
(63) Continuation of application No. PCT/JP2022/004625, filed on Feb. 7, 2022.

(30) Foreign Application Priority Data
Jul. 28, 2021 (JP) 2021-122959

(51) Int. Cl. G08B 21/18

(52) U.S. Cl. CPC G08B 21/18

(57) ABSTRACT

An information notification device is configured to: acquire apparatus information on an apparatus; determine an action for the apparatus based on the apparatus information; determine an executor who is to perform the determined action from among multiple users; determine a notification target person to be notified that the executor is to perform the action with reference to relationship information indicating a relationship among the multiple users; and notify the determined notification target person of notification information indicating that the executor is to perform the action.

### FIELD OF INVENTION

The present disclosure relates to a technique for determining a user to be notified of information among multiple users and notifying the determined user of the information.

### BACKGROUND ART

For example, Patent Literature 1 discloses that when a failure is detected in an air conditioner by its self-diagnosis, a software cell of failure information indicating the failure is generated, the generated software cell being received and held by a refrigerator, and when a door of the refrigerator is opened by a user, the refrigerator notifies the user that the air conditioner has failed based on the held software cell.

Unfortunately, the conventional technique described above does not consider determining a notification target person in consideration of a relationship between a user who performs an action on an apparatus and another user, and thus is required to be further improved.
Patent Literature 1: JP 2005-339365 A

### SUMMARY OF THE INVENTION

The present disclosure has been made to solve the above problem, and an object of the present disclosure is to provide a technique capable of causing an executor to reliably perform an action on an apparatus.

An information notification method according to the present disclosure includes, by a computer: acquiring apparatus information on an apparatus; determining an action for the apparatus based on the apparatus information; determining an executor who is to perform the determined action from among multiple users; determining a notification target person to be notified that the executor is to perform the action with reference to relationship information indicating a relationship among the multiple users; and notifying the determined notification target person of notification information indicating that the executor is to perform the action.

The present disclosure enables not only the notification target person, having a strong relationship with the executor, to prompt the executor to perform the action on the apparatus, but also the executor to reliably perform the action on the apparatus because the notification target person is determined in consideration of the relationship between the executor who performs the action on the apparatus and another user.

### BRIEF DESCRIPTION OF THE DRAWINGS

FIG. 1 is a diagram illustrating an example of a configuration of an information notification system according to a first embodiment of the present disclosure.

FIG. 2 is a diagram illustrating an example of a configuration of an information notification device according to the first embodiment of the present disclosure.

FIG. 3 is a diagram illustrating an example of apparatus information according to the first embodiment.

FIG. 4 is a diagram illustrating an example of a notification necessity management table according to the first embodiment.

FIG. 5 is a diagram illustrating an example of an action content management table according to the first embodiment.

FIG. 6 is a diagram illustrating an example of an executor management table according to the first embodiment.

FIG. 7 is a diagram illustrating an example of relationship information according to the first embodiment.

FIG. 8 is a diagram illustrating an example of a notification method determined based on the relationship information illustrated in FIG. 7.

FIG. 9 is a flowchart for illustrating information notification processing with the information notification device according to the first embodiment of the present disclosure.

FIG. 10 is a diagram illustrating an example of a notification screen displayed on a mobile terminal held by a notification target person according to the first embodiment.

FIG. 11 is a diagram illustrating another example of a notification screen displayed on a mobile terminal held by a notification target person according to the first embodiment.

FIG. 12 is a diagram illustrating an example of a configuration of an information notification device according to a second embodiment of the present disclosure.

FIG. 13 is a diagram illustrating an example of a response rule in which response time from notification to a notification target person to time when an action is performed is associated with a response level according to the second embodiment.

FIG. 14 is a diagram illustrating an example of a notification method determined based on the response level illustrated in FIG. 13.

FIG. 15 is a first flowchart for illustrating information notification processing with the information notification device according to the second embodiment of the present disclosure.

FIG. 16 is a second flowchart for illustrating information notification processing with the information notification device according to the second embodiment of the present disclosure.

### DETAILED DESCRIPTION

(Underlying Knowledge of Present Disclosure)

The above conventional technique causes a software cell of failure information indicating a failure to be transmitted to a refrigerator when the failure of an air conditioner is detected, and causes a user to be notified of the failure of the air conditioner based on the software cell when a door of the refrigerator is opened by the user.

In this case, the failure of the air conditioner is notified to an unidentified user who has opened the door of the refrigerator, and is not notified to a specific user who requests repair of the air conditioner.

For filter replacement or the like for a washing machine, an executor who performs actions for the apparatus may be determined in advance. For example, when a father in home is determined in advance to perform filter replacement of a washing machine, it is conceivable to directly notify the father of the filter replacement of the washing machine. However, the father may not necessarily reliably replace the filter of the washing machine even if the filter replacement of the washing machine is notified to the father, but may possibly reliably replace the filter when being prompted by another user having a strong relationship with the father in the home, such as a mother or a child.

To solve the above problem, an information notification method according to an aspect of the present disclosure includes, by a computer: acquiring apparatus information on an apparatus; determining an action for the apparatus based on the apparatus information; determining an executor who is to perform the determined action from among multiple users; determining a notification target person to be notified that the executor is to perform the action with reference to relationship information indicating a relationship among the multiple users; and notifying the determined notification target person of notification information indicating that the executor is to perform the action.

With this configuration, the action on the apparatus is determined based on the apparatus information on the apparatus, and the executor who is to perform the determined action is determined from among the multiple users. Then, the notification target person to be notified that the executor is to perform the action is determined with reference to the relationship information indicating the relationship among the multiple users, and the determined notification target person is notified of the notification information indicating that the executor is to perform the action.

Thus, the configuration enables not only the notification target person, having a strong relationship with the executor, to prompt the executor to perform the action on the apparatus, but also the executor to reliably perform the action on the apparatus because the notification target person is determined in consideration of the relationship between the executor of performing the action on the apparatus and another user.

In the information notification method described above, the notification target person may be a user different from the executor, and the notification information may include information prompting the notification target person to notify the executor that the executor is to perform the action.

With this configuration, the executor can be more strongly prompted to perform the action because the action to be performed on the apparatus is notified to the executor via a user different from the executor, instead of being directly notified to the executor.

In the information notification method described above, the notification target person may be the same user as the executor.

With this configuration, the executor can be reliably notified of the action to be performed on the apparatus.

In the information notification method described above, the relationship information may include table information in which each of the multiple users is associated with a priority for corresponding one of the multiple users, and in determining the notification target person, a user having a highest priority and being associated with the executor is determined as the notification target person with reference to the relationship information.

With this configuration, a user having a strong relationship with the user being the executor can be easily determined as the notification target person by associating in advance each of the multiple users with the priority for the corresponding one of the multiple users according to the relationship among the users.

In the information notification method described above, in determining the notification target person, when a user having a highest priority and being associated with the executor belongs to a layer group to which the executor belongs, with reference to layer information indicating that each of the multiple users belongs to which one of multiple hierarchical layer groups and the relationship information, the user having the highest priority and the executor may be each determined as the notification target person, and when the user having the highest priority associated with the executor belongs to a layer group to which the executor does not belong, only the user having the highest priority may be determined as the notification target person.

With this configuration, each of the multiple users belongs to any one of the multiple hierarchical layer groups. When the user having the highest priority and being associated with the executor belongs to the layer group to which the executor belongs, the user having the highest priority and the executor are each determined as the notification target person. When the user having the highest priority and being associated with the executor belongs to the layer group to which the executor does not belong, only the user having the highest priority is determined as the notification target person. Thus, the notification target person can be determined in consideration of a hierarchical relationship between the user having the highest priority and the executor.

The information notification method described above may further include: acquiring execution completion information indicating that the action is performed on the apparatus when the action is performed on the apparatus; determining each of the multiple users or a user other than the user who is notified of the notification information first among the multiple users as the notification target person, when the execution completion information is not acquired even when a predetermined time has elapsed after the notification information is notified; and notifying the determined notification target person of the notification information again.

With this configuration, because the notification information is notified again to each of the multiple users when the executor does not perform the action on the apparatus even when the predetermined time has elapsed after the notification information is notified, a user other than the executor among the multiple users can prompt the executor to perform the action on the apparatus. Because the notification information is notified again to the user other than the user who is notified of the notification information first among the multiple users when the executor does not perform the action on the apparatus even when the predetermined time has elapsed after the notification information is notified, a user other than the user who is notified of the notification information first among the multiple users can prompt the executor to perform the action on the apparatus.

The information notification method described above may further include restricting use of the apparatus when the execution completion information is not acquired even when a predetermined time has elapsed after the notification information is notified again.

With this configuration, the executor can be more strongly prompted to perform the action when the execution completion information is not acquired even when a predetermined time has elapsed after the notification information is notified again because the use of the apparatus is restricted.

The information notification method described above may further include: measuring a response time from when the notification information is notified until the executor performs the action on the apparatus to store the response time in a memory; acquiring execution completion information indicating that the action is performed on the apparatus when the action is performed on the apparatus; re-determining the notification target person in accordance with previous response time of the executor when the execution completion information is not acquired even when a predetermined time has elapsed after the notification information is notified; and notifying the notification information again to the re-determined notification target person.

With this configuration, the response time from when the notification information is notified until the executor performs the action on the apparatus is measured, and the notification target person is re-determined in accordance with the previous response time of the executor when the execution completion information is not acquired even when the predetermined time has elapsed after the notification information is notified. For example, when the previous response time is shorter than the predetermined time, the user who is notified of the notification information first is re-determined as the notification target person, and when the previous response time is equal to or longer than the predetermined time, a user different from the user who is notified of the notification information first is redetermined as the notification target person. This configuration enables the user, different from the user who is notified of the notification information first, to prompt the executor, whose previous response time is relatively long, to perform the action on the apparatus.

In the information notification method described above, the apparatus information may include information on an error that has occurred in the apparatus, information on maintenance of the apparatus, or information indicating a predetermined function of the apparatus, selected by a user.

With this configuration, an action on the apparatus can be determined based on the information on an error that has occurred in the apparatus, the information on maintenance of the apparatus, or the information indicating a predetermined function of the apparatus, selected by the user.

In the information notification method described above, in notifying the notification information, the notification information may be transmitted to a terminal held by the notification target person.

With this configuration, the notification information can be reliably notified to the notification target person because the notification information is transmitted to the terminal held by the notification target person.

In the information notification method described above, in notifying the notification information, the notification information may be transmitted to an apparatus that is used most frequently by the notification target person with reference to use history information indicating use history of multiple apparatuses of the respective multiple users.

With this configuration, the notification information can be reliably notified to the notification target person because the notification information is transmitted to the apparatus that is used most frequently by the notification target person.

In the information notification method described above, in notifying the notification information, when the executor is the notification target person, a time period in which the notification target person uses the apparatus on which the action is performed may be identified with reference to the use history information indicating use history of multiple apparatuses of the respective multiple users, and the notification information may be transmitted to an apparatus to be used by the notification target person by a predetermined time before the identified time period.

With this configuration, the executor can perform the action on the apparatus when using the apparatus because the notification information is notified by the apparatus to be used by the notification target person by the predetermined time before the time period in which the notification target person uses the apparatus on which the action is to be performed.

In the information notification method described above, in notifying the notification information, a series of actions in which the notification target person uses the respective multiple apparatuses may be grouped and arranged in time series with reference to the use history information indicating use history of the multiple apparatuses of the respective multiple users, a group may be identified in which the notification target person uses the apparatus on which the action is to be performed, and the notification information may be transmitted to an apparatus used in a last action of a group immediately before the identified group, an apparatus used in a first action of the identified group, or an apparatus used in a last action of the identified group.

With this configuration, the notification information can be reliably notified to the notification target person because the group is identified in which the notification target person uses the apparatus on which the action is to be performed, and the notification information is notified by the apparatus used in the last action of the group immediately before the identified group, the apparatus used in the first action of the identified group, or the apparatus used in the last action of the identified group.

The present disclosure can be implemented not only as the information notification method for performing characteristic processing as described above, but also as an information notification device or the like having a characteristic configuration corresponding to a characteristic method performed according to the information notification method. The present disclosure can also be implemented as a computer program that causes a computer to execute characteristic processing included in the information notification method described above. Thus, even other aspects below can achieve an effect as in the information notification method.

An information notification device according to another aspect of the present disclosure includes: an acquisition unit configured to acquire apparatus information on an apparatus; an action determination unit configured to determine an action for the apparatus based on the apparatus information; an executor determination unit configured to determine an executor who is to perform the determined action from among multiple users; a notification target person determination unit configured to determine a notification target person to be notified that the executor is to perform the action with reference to relationship information indicating a relationship among the multiple users; and a notification unit configured to notify the determined notification target person of notification information indicating that the executor is to perform the action.

A non-transitory computer readable recording medium storing an information notification program according to yet another aspect of the present disclosure causes a computer to perform the functions of: acquiring apparatus information on an apparatus; determining an action for the apparatus based on the apparatus information; determining an executor who is to perform the determined action from among multiple users; determining a notification target person to be notified that the executor is to perform the action with reference to relationship information indicating a relationship among the multiple users; and notifying the determined notification target person of notification information indicating that the executor is to perform the action.

Embodiments of the present disclosure will be described below with reference to the accompanying drawings. The embodiments below are examples of embodying the present disclosure, and are not intended to limit the technical scope of the present disclosure.

### First Embodiment

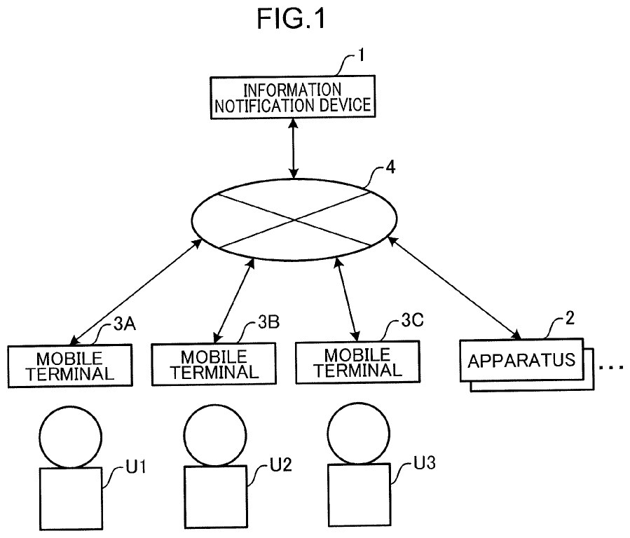

FIG. 1 is a diagram illustrating an example of a configuration of an information notification system according to a first embodiment of the present disclosure. The information notification system illustrated in FIG. 1 includes an information notification device 1, an apparatus 2, and mobile terminals 3A, 3B, and 3C.

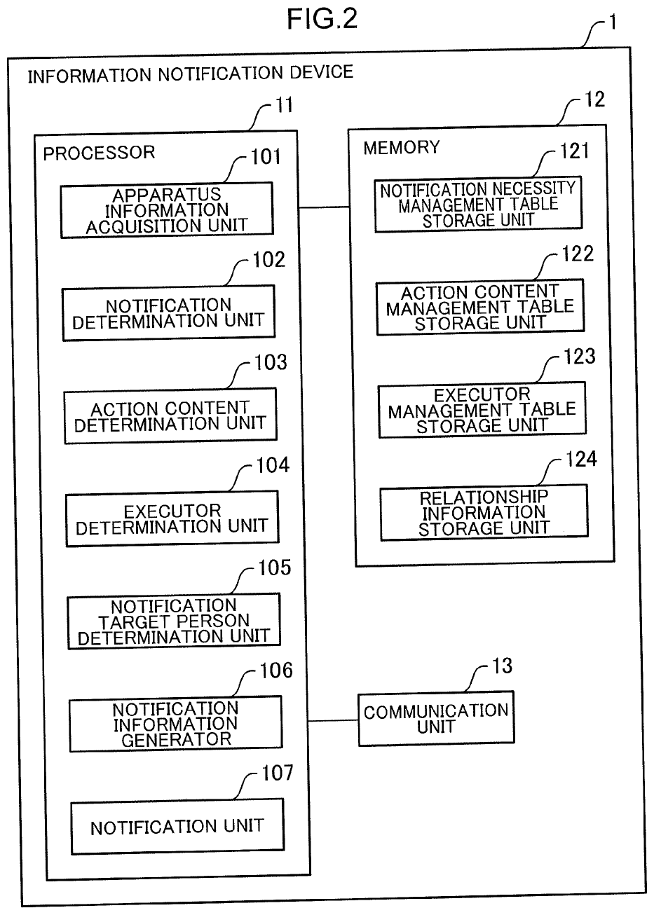

The information notification device 1 is a cloud server, an edge server, or an integrated terminal, for example, and is communicably connected to the apparatus 2 and the mobile terminals 3A, 3B, and 3C via a network 4. The integrated terminal is installed in a living room in a house, for example, and is a controller for integrally controlling multiple apparatuses 2 used in the house. The network 4 is the Internet, for example. The information notification device 1 has a configuration that will be described later with reference to FIG. 2.

The apparatuses 2 are installed in a house of a first user U1, a second user U2, and a third user U3, and examples of the apparatuses 2 include a home appliance such as a refrigerator, a washing machine, a microwave oven, or a television, house equipment such as a ventilator, a lighting device, or a hot water supply device, and a sensor such as a motion sensor. The information notification system includes multiple apparatuses 2. The apparatuses 2 each periodically transmit apparatus information on corresponding one of the apparatuses 2 to the information notification device 1.

The first user U1, the second user U2, and the third user U3 are family members. For example, the first user U1 is a father, the second user U2 is a mother, and the third user U3 is a child.

The mobile terminals 3A, 3B, and 3C are smartphones or tablet computers, for example, and are held by the first user U1, the second user U2, and the third user U3, respectively. The mobile terminals 3A, 3B, and 3C receive notification information transmitted by the information notification device 1. The notification information indicates that an executor is to perform an action.

FIG. 2 is a diagram illustrating an example of the configuration of the information notification device 1 according to the first embodiment of the present disclosure.

The information notification device 1 illustrated in FIG. 2 includes a processor 11, a memory 12, and a communication unit 13.

The processor 11 is a central processing unit (CPU), for example. The processor 11 implements an apparatus information acquisition unit 101, a notification determination unit 102, an action content determination unit 103, an executor determination unit 104, a notification target person determination unit 105, a notification information generator 106, and a notification unit 107.

The memory 12 is a storage device capable of storing various types of information, such as a random access memory (RAM), a hard disk drive (HDD), a solid state drive (SSD), or a flash memory. The memory 12 implements a notification necessity management table storage unit 121, an action content management table storage unit 122, an executor management table storage unit 123, and a relationship information storage unit 124.

The communication unit 13 receives the apparatus information transmitted by the apparatus 2. The communication unit 13 outputs the received apparatus information to the apparatus information acquisition unit 101.

The apparatus information acquisition unit 101 acquires the apparatus information on the apparatus 2.

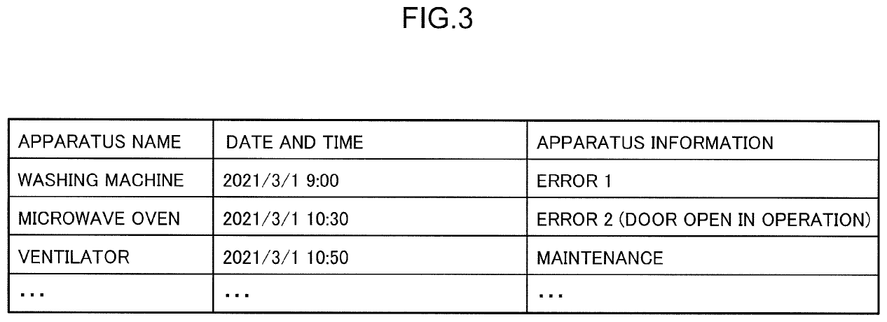

FIG. 3 is a diagram illustrating an example of the apparatus information according to the first embodiment.

As illustrated in FIG. 3, the apparatus information acquisition unit 101 acquires an apparatus name, date and time, and apparatus information. The apparatus name is a name of the apparatus 2, such as a washing machine, a microwave oven, or a ventilator. The apparatus name may be an identification number, a model number, or a product number for identifying the apparatus. The date and time are at which the apparatus information is received. The date and time may be at which the apparatus information is transmitted or an event related to the apparatus information occurs.

The apparatus information includes information on an error that has occurred in the apparatus 2, information on maintenance of the apparatus 2, or information indicating a predetermined function of the apparatus 2, selected by the user, for example. FIG. 3 illustrates apparatus information “error 1” on an error that has occurred in the washing machine, apparatus information “error 2” on an error that has occurred in the microwave oven, and apparatus information “maintenance” on maintenance that has occurred in the ventilator. Examples of the information on maintenance include a degree of contamination of a filter of the ventilator, the number of days elapsed from time of replacement of the filter, the number of days elapsed from time when the ventilator has been attached, or the number of days elapsed from the last replacement of the filter.

The apparatus information acquisition unit 101 acquires apparatus information transmitted by the apparatus 2 periodically (e.g., every 30 seconds).

The notification determination unit 102 determines whether to notify the notification information based on the apparatus information acquired by the apparatus information acquisition unit 101 with reference to the notification necessity management table stored in the notification necessity management table storage unit 121.

The notification necessity management table storage unit 121 stores in advance the notification necessity management table in which apparatus information is associated with necessity or unnecessity of notification.

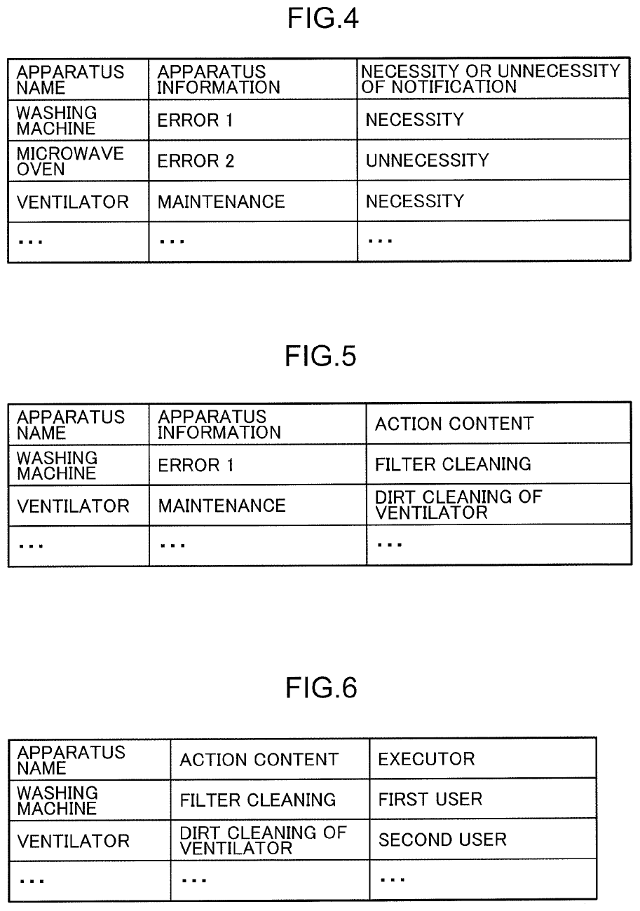

FIG. 4 is a diagram illustrating an example of the notification necessity management table according to the first embodiment.

FIG. 4 illustrates the notification necessity management table in which an apparatus name, apparatus information, and necessity or unnecessity of notification are associated with one another. For example, the apparatus information “error 1” of the washing machine is associated with necessity of notification, the apparatus information “error 2” of the microwave oven is associated with unnecessity of notification, and the apparatus information “maintenance” of the ventilator is associated with necessity of notification.

The notification necessity management table may be provided by a manufacturer of the apparatus 2 or may be input by a user.

The action content determination unit 103 determines an action for the apparatus 2 based on the apparatus information. The action content determination unit 103 determines the action content associated with the apparatus information with reference to the action content management table stored in the action content management table storage unit 122.

The action content management table storage unit 122 stores in advance the action content management table in which apparatus information is associated with an action content that is to be acted on the apparatus by a user.

FIG. 5 is a diagram illustrating an example of the action content management table according to the first embodiment.

FIG. 5 illustrates the action content management table in which an apparatus name, apparatus information, and an action content are associated with one another. For example, the apparatus information “error 1” of the washing machine is associated with filter cleaning, and the apparatus information “maintenance” of the ventilator is associated with dirt cleaning of the ventilator.

The action content management table may be provided by a manufacturer of the apparatus 2 or may be input by a user.

The executor determination unit 104 determines an executor to perform the action determined by the action content determination unit 103, from among multiple users. The executor determination unit 104 determines a user associated with the action content as the executor with reference to an executor management table stored in the executor management table storage unit 123.

The executor management table storage unit 123 stores in advance the executor management table in which an action content is associated with an executor who performs the action content.

FIG. 6 is a diagram illustrating an example of the executor management table according to the first embodiment.

FIG. 6 illustrates the executor management table in which an apparatus name, an action content, and an executor are associated with one another. For example, an action content “filter cleaning” of the washing machine is associated with the first user, and an action content “dirt cleaning of a ventilator” of the ventilator is associated with the second user. That is, the first user performs the filter cleaning, and the second user performs the dirt cleaning of the ventilator.

The executor management table is input in advance by a user. Any one of the multiple users inputs an executor of an action to be performed on an apparatus, and registers the executor in the executor management table.

The notification target person determination unit 105 determines a notification target person to be notified that the executor is to perform the action with reference to relationship information indicating a relationship among the multiple users. The notification target person determination unit 105 determines a user having a highest priority associated with the executor as the notification target person with reference to the relationship information.

The relationship information storage unit 124 stores in advance the relationship information indicating the relationship among the multiple users.

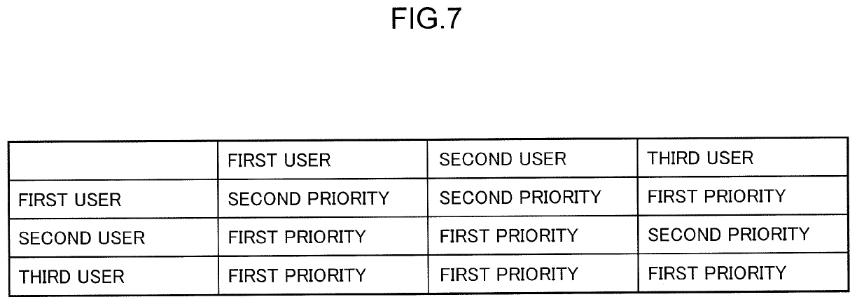

FIG. 7 is a diagram illustrating an example of the relationship information according to the first embodiment.

FIG. 7 illustrates the relationship information that includes table information indicating a priority of each of the multiple users for corresponding one of the multiple users. The priority is represented by an order of priority.

For example, when the first user is the executor, an order of priority of the first user for the first user is second, an order of priority of the second user for the first user is second, and an order of priority of the third user for the first user is first. When the second user is the executor, an order of priority of the first user for the second user is first, an order of priority of the second user for the second user is first, and an order of priority of the third user for the second user is second. When the third user is the executor, an order of priority of the first user for the third user is first, an order of priority of the second user for the third user is first, and an order of priority of the third user for the third user is first.

The order of priority is determined in advance according to a relationship among the users. For example, when the first user is a father, the third user is a child, and the first user is an executor, the notification target person determination unit 105 determines the third user having the first order of priority as the notification target person. Then, the third user notifies the first user of an action to be performed by the first user. As described above, when a user having the strongest relationship (highest priority) with the first user is the third user, the information notification device 1 causes the third user to notify the first user of the action to be performed by the first user.

The relationship information is input in advance by a user. Any one of the multiple users inputs the priority of each of the multiple users for the corresponding one of the multiple users, and registers the priority in the relationship information storage unit 124 as the relationship information.

The notification information generator 106 generates notification information indicating that the executor is to perform the action.

The notification unit 107 notifies the notification target person, who is determined by the notification target person determination unit 105, of notification information indicating that the executor is to perform the action. The notification unit 107 transmits the notification information generated by the notification information generator 106 to a mobile terminal held by the notification target person determined by the notification target person determination unit 105 via the communication unit 13. The communication unit 13 transmits the notification information to the mobile terminal.

For example, FIG. 7 illustrates the relationship information in which when the first user is the executor, the notification target person is the third user different from the executor. The notification information includes information prompting the notification target person to notify the executor that the executor is to perform the action. FIG. 7 illustrates the relationship information in which when the second user is the executor, the notification target person is the first user different from the executor and the second user being the executor.

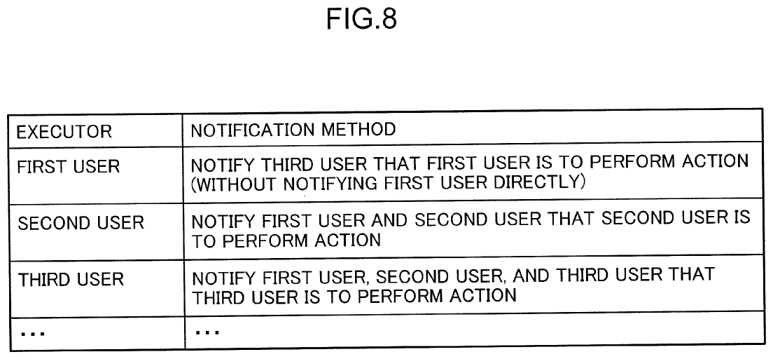

FIG. 8 is a diagram illustrating an example of a notification method determined based on the relationship information illustrated in FIG. 7.

As illustrated in FIG. 8, when the first user is the executor, the information notification device 1 notifies the third user that the first user is to perform the action. When the second user is the executor, the information notification device 1 notifies the first user and the second user that the second user is to perform the action. When the third user is the executor, the information notification device 1 notifies the first user, the second user, and the third user that the third user is to perform the action.

Subsequently, information notification processing with the information notification device 1 according to the first embodiment of the present disclosure will be described.

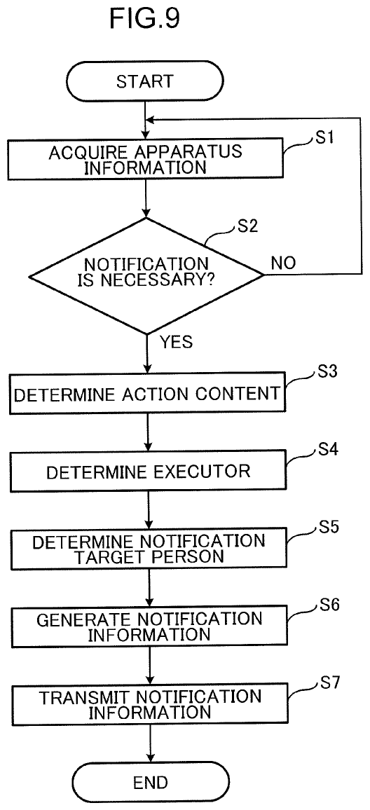

FIG. 9 is a flowchart for the illustrating information notification processing with the information notification device 1 according to the first embodiment of the present disclosure.

In step S1, the apparatus information acquisition unit 101 first acquires apparatus information transmitted by the apparatus 2. The communication unit 13 periodically receives apparatus information from each of multiple apparatuses 2 installed in a house. Thus, the information notification processing illustrated in FIG. 9 is performed at timing of receiving the apparatus information.

In subsequent step S2, the notification determination unit 102 determines whether notification is necessary based on the apparatus information acquired by the apparatus information acquisition unit 101 with reference to the notification necessity management table stored in the notification necessity management table storage unit 121. The notification necessity management table shows the apparatus information associated with necessity or unnecessity of notification. The notification determination unit 102 determines whether notification is necessary for the apparatus information acquired by the apparatus information acquisition unit 101.

Here, when it is determined that the notification is unnecessary (NO in step S2), the processing returns to step S1.

In contrast, when it is determined that the notification is necessary (YES in step S2), the action content determination unit 103 determines an action content for the apparatus 2 based on the apparatus information in step S3, with reference to the action content management table stored in the action content management table storage unit 122. The action content management table shows apparatus information associated with an action content that is to be performed on the apparatus by a user. The action content determination unit 103 reads out the action content corresponding to the apparatus information acquired by the apparatus information acquisition unit 101 from the action content management table to determine the action content.

In subsequent step S4, the executor determination unit 104 determines an executor to perform the action content determined by the action content determination unit 103 with reference to the executor management table stored in the executor management table storage unit 123. The executor management table shows the action content associated with the executor who performs the action content. The executor determination unit 104 reads out the executor corresponding to the action content determined by the action content determination unit 103 from the executor management table to determine the executor.

In subsequent step S5, the notification target person determination unit 105 determines a notification target person to be notified that the executor is to perform the action with reference to the relationship information stored in the relationship information storage unit 124. The relationship information indicates which user is preferentially notified when each user is determined to be the executor according to the relationship among the multiple users. The notification target person determination unit 105 determines a user having the highest priority associated with the user determined to be the executor by the executor determination unit 104 as the notification target person.

In subsequent step S6, the notification information generator 106 generates notification information indicating that the executor is to perform the action.

In subsequent step S7, the notification unit 107 transmits the notification information generated by the notification information generator 106 to a mobile terminal held by the notification target person determined by the notification target person determination unit 105 via the communication unit 13.

Thus, the action on the apparatus 2 can be determined based on the apparatus information on the apparatus 2, and the executor who is to perform the determined action can be determined from among the multiple users. Then, the notification target person to be notified that the executor is to perform the action is determined with reference to the relationship information indicating the relationship among the multiple users, and the determined notification target person is notified of the notification information indicating that the executor is to perform the action.

Thus, the processing enables not only the notification target person, having a strong relationship with the executor, to prompt the executor to perform the action on the apparatus 2, but also the executor to reliably perform the action on the apparatus 2 because the notification target person is determined in consideration of the relationship between the executor who performs the action on the apparatus 2 and another user.

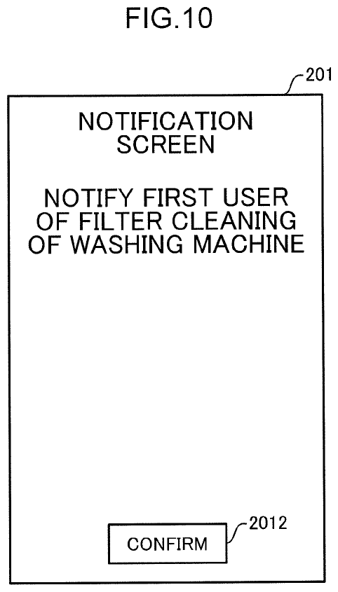

FIG. 10 is a diagram illustrating an example of a notification screen displayed on a mobile terminal held by a notification target person according to the first embodiment.

When the first user is determined as the executor and the third user is determined as the notification target person based on the relationship information illustrated in FIG. 7, a mobile terminal 3C held by the third user displays a notification screen 201 prompting the first user to be notified of an action to be performed by the first user. For example, the notification screen 201 includes notification information prompting notification of filter cleaning of the washing machine to the first user. The third user having viewed the notification screen 201 notifies the first user to clean the filter of the washing machine.

The notification screen 201 also includes a confirmation button 2012. When the confirmation button 2012 is touched by the third user, the mobile terminal 3C transmits notification completion information indicating that the third user has checked the notification information to the information notification device 1.

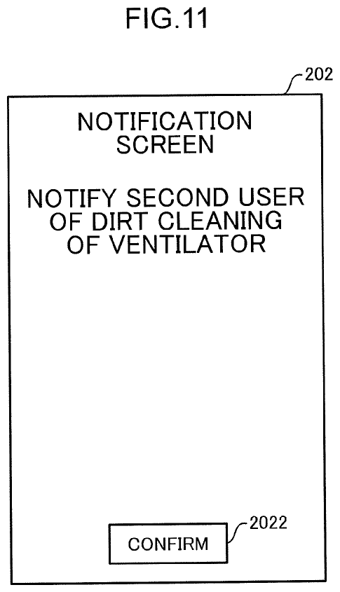

FIG. 11 is a diagram illustrating another example of a notification screen displayed on a mobile terminal held by a notification target person according to the first embodiment.

When the second user is determined as the executor and the first user and the second user are each determined as the notification target person based on the relationship information illustrated in FIG. 7, mobile terminals 3A and 3B held by the first user and the second user, respectively, display a notification screen 202 prompting the first user and the second user to be notified of an action to be performed by the second user. For example, the notification screen 202 includes notification information prompting notification of dirt cleaning of the ventilator to the second user.

The notification screen 202 also includes a confirmation button 2022. When the confirmation button 2022 is touched by the first user, the mobile terminal 3A transmits notification completion information indicating that the first user has checked the notification information to the information notification device 1. When the confirmation button 2022 is touched by the second user, the mobile terminal 3B transmits notification completion information indicating that the second user has checked the notification information to the information notification device 1.

The notification screen notified to the mobile terminal 3A of the first user and the notification screen notified to the mobile terminal 3B of the second user may be identical or different. That is, when the notification target person is the executor, the mobile terminal 3B may display a notification screen that notifies the notification target person of an action to be performed by the executor.

The notification target person determination unit 105 according to the first embodiment may determine a user having the second order of priority for the user being the executor as the notification target person when the executor does not perform the action content even when a predetermined time has elapsed after the notification information is transmitted to the notification target person. Then, the notification unit 107 may transmit the notification information to a mobile terminal held by the determined notification target person. The apparatus 2 may detect that the executor has performed the action content. When the action is performed on the apparatus 2, the apparatus 2 may transmit execution completion information to the information notification device 1, the information indicating that the action is performed on the apparatus 2. The communication unit 13 may receive the execution completion information transmitted by the apparatus 2. The processor 11 may further include an execution completion information acquisition unit that acquires the execution completion information.

The notification target person determination unit 105 according to the first embodiment may determine each of the multiple users or a user other than the user who is notified of the notification information first among the multiple users as the notification target person when the execution completion information is not acquired even when a predetermined time has elapsed after notification of the notification information. Then, the notification unit 107 may notify the notification target person, who is determined by the notification target person determination unit 105, of the notification information again.

The processor 11 may further include an apparatus use restriction unit that restricts use of the apparatus when the execution completion information is not acquired even when a predetermined time has elapsed after the notification information is notified again. For example, the apparatus use restriction unit may prevent the apparatus 2 from receiving operation of the user. When the apparatus 2 is capable of identifying a user and the user being the executor uses the apparatus 2, the apparatus use restriction unit may cause operation of the user not to be received. When the execution completion information is acquired after use of the apparatus is restricted, the apparatus use restriction unit may release the restriction. When a predetermined time has elapsed after the use of the apparatus is restricted, the apparatus use restriction unit may release the restriction.

When the executor performs the action content at a predetermined frequency, the notification target person determination unit 105 may determine only the executor as the notification target person instead of determining the notification target person with reference to the relationship information. The predetermined frequency is 9/10, for example. That is, when the notification target person is notified of the notification information 10 times and the executor performs the action content 9 times, the notification target person determination unit 105 may determine only the executor as the notification target person. Then, when the executor stops performing the action content at the predetermined frequency after only the executor is determined as the notification target person, the notification target person determination unit 105 may determine the notification target person with reference to the relationship information.

When the executor performs the action content at the predetermined frequency and the executor is included in the notification target person with reference to the relationship information, the notification target person determination unit 105 may determine at least one user including the executor as the notification target person.

When the executor continuously performs the action content a predetermined number of times or more, the notification target person determination unit 105 may determine only the executor as the notification target person instead of determining the notification target person with reference to the relationship information. The predetermined number of times is five times, for example.

When the executor performs the action content within a predetermined time after last notification of the notification information to the notification target person, the notification target person determination unit 105 may determine only the executor as the notification target person instead of determining the notification target person with reference to the relationship information.

The memory 12 may include a layer information storage unit that stores layer information indicating that each of the multiple users belongs to which of multiple hierarchical layer groups. For example, the father and the mother belong to a first layer group, and the child belongs to a second layer group different in hierarchy from the first layer group. The notification target person determination unit 105 may determine whether the user having the highest priority associated with the executor belongs to a layer group to which the executor belongs with reference to the layer information and the relationship information. Then, when the user having the highest priority associated with the executor belongs to the layer group to which the executor belongs, the notification target person determination unit 105 may determine each of the user having the highest priority and the executor as the notification target person. In contrast, when the user having the highest priority associated with the executor belongs to a layer group to which the executor does not belong, the notification target person determination unit 105 may determine only the user having the highest priority as the notification target person.

When a predetermined function of the apparatus 2 is used by the user, the apparatus 2 may transmit apparatus information indicating that the predetermined function is used to the information notification device 1. For example, when the apparatus 2 is a microwave oven and its oven function is used by the user, the apparatus 2 may transmit apparatus information indicating that the oven function is used to the information notification device 1. The information notification device 1 counts the number of uses of multiple functions of the apparatus 2 with the respective users. When the apparatus 2 can be operated from a mobile terminal, the apparatus 2 can identify a user who uses the apparatus 2 and a function to be used by identifying the operated mobile terminal. When the apparatus 2 can be operated by voice, the apparatus 2 can identify a user who uses the apparatus 2 and a function to be used by voice recognition. When the number of uses of the predetermined function used by the user (executor) is smaller than a predetermined number of uses, the notification target person determination unit 105 may determine each of a user with the number of uses equal to or larger than the predetermined number of uses and the user (executor) with the number of uses smaller than the predetermined number of uses as the notification target person. When the number of uses of the predetermined function used by the user (executor) is equal to or larger than the predetermined number of uses, the notification target person determination unit 105 does not determine the notification target person. This is because the user with the number of uses of the predetermined function, the number being equal to or larger than the predetermined number of uses, has mastered the predetermined function without notification.

The action content may be associated in advance with an execution scheduled period from notification of the notification information until the action content is performed. Then, when the execution scheduled period associated with the action content determined by the action content determination unit 103 is equal to or longer than a predetermined period, the notification target person determination unit 105 may determine the notification target person with reference to the relationship information. In contrast, when the execution scheduled period associated with the action content determined by the action content determination unit 103 is shorter than the predetermined period, or when the determined action content is to be immediately performed, the notification target person determination unit 105 may determine each of the multiple users as the notification target person without referring to the relationship information.

When the executor is not associated with the determined action content and is not determined by the executor determination unit 104, the notification target person determination unit 105 may determine each of the multiple users as the notification target person.

Although the notification information is notified by the mobile terminal held by the notification target person in the first embodiment, the present disclosure is not particularly limited thereto. The notification information may be notified by any of multiple apparatuses installed in a house of the notification target person.

That is, notification unit 107 may transmit the notification information to an apparatus that is used most frequently by the notification target person with reference to use history information indicating use history of multiple apparatuses of the respective multiple users. In this case, the memory 12 stores the use history information indicating the use history of the multiple apparatuses of the respective multiple users. The notification unit 107 may transmit the notification information to an apparatus that is used most frequently by the notification target person among multiple apparatuses each including a display or a voice output unit.

When the executor is the notification target person, the notification unit 107 may identify a time period in which the notification target person uses the apparatus on which the action is to be performed with reference to the use history information indicating the use history of the multiple apparatuses of the respective multiple users. Then, the notification unit 107 may transmit the notification information to the apparatus used by the notification target person by a predetermined time before the identified time period.

The notification unit 107 may group a series of actions in which the notification target person uses each of the multiple apparatuses and arrange groups in time series with reference to the use history information indicating the use history of the multiple apparatuses of the respective multiple users to identify a group in which the notification target person uses an apparatus on which the action is to be performed. Then, the notification unit 107 may transmit the notification information to an apparatus used in the last action in a group immediately before the identified group, an apparatus used in the first action in the identified group, or an apparatus used in the last action in the identified group.

For example, a meal group includes an action of a user opening a refrigerator, an action of the user cutting an ingredient, an action of the user putting the ingredient in a microwave oven, an action of the user cooking the ingredient in the microwave oven, an action of the user taking out a dish cooked in the microwave oven, and an action of the user eating the dish. For example, a relaxation group includes an action of the user watching television and an action of the user listening to music. For example, a washing group includes an action of the user putting laundry into a washing machine, an action of the user operating the washing machine, an action of the user taking out the laundry from the washing machine, and an action of the user drying the laundry.

When the meal group, the relaxation group, and the washing group are performed in time series and an action to be performed by the executor is filter cleaning of the washing machine, for example, the notification unit 107 identifies a group in which the notification target person uses the apparatus on which the action is to be performed as the washing group. Then, the notification unit 107 may transmit the notification information to an apparatus used in the action of the user listening to music, or to a music player, the action being the last action in the relaxation group immediately before the identified washing group. At this time, when use of the music player with the user is detected, the notification unit 107 may transmit the notification information to the music player. The notification unit 107 may also predict a time period in which the music player is used by the user, and transmit the notification information to the music player when time reaches the predicted time period.

The notification unit 107 may also transmit the notification information to an apparatus used in the action of the user putting laundry into the washing machine, or to the washing machine, the action being the first action in the identified washing group. At this time, when putting the laundry into the washing machine is detected, the notification unit 107 may transmit the notification information to the washing machine. The notification unit 107 may also predict a time period in which laundry is put in the washing machine by the user, and transmit the notification information to the washing machine when time reaches the predicted time period.

The notification unit 107 may also transmit the notification information to an apparatus used in the action of the user drying the laundry, or to the washing machine, the action being the last action in the identified washing group. At this time, when the action of the user drying the laundry is detected, the notification unit 107 may transmit the notification information to the washing machine. The notification unit 107 may also predict a time period in which the user dries the laundry, and transmit the notification information to the washing machine when time reaches the predicted time period.

### Second Embodiment

The first embodiment allows the information notification processing to end when the notification information is transmitted. In contrast, a second embodiment allows response time from notification of notification information to when an executor performs an action on an apparatus to be measured and stored in a memory. Then, when the executor does not perform the action even when a predetermined time has elapsed after the notification information is notified, a notification target person is determined based on previous response time of the executor, and the determined notification target person is notified again of the notification information.

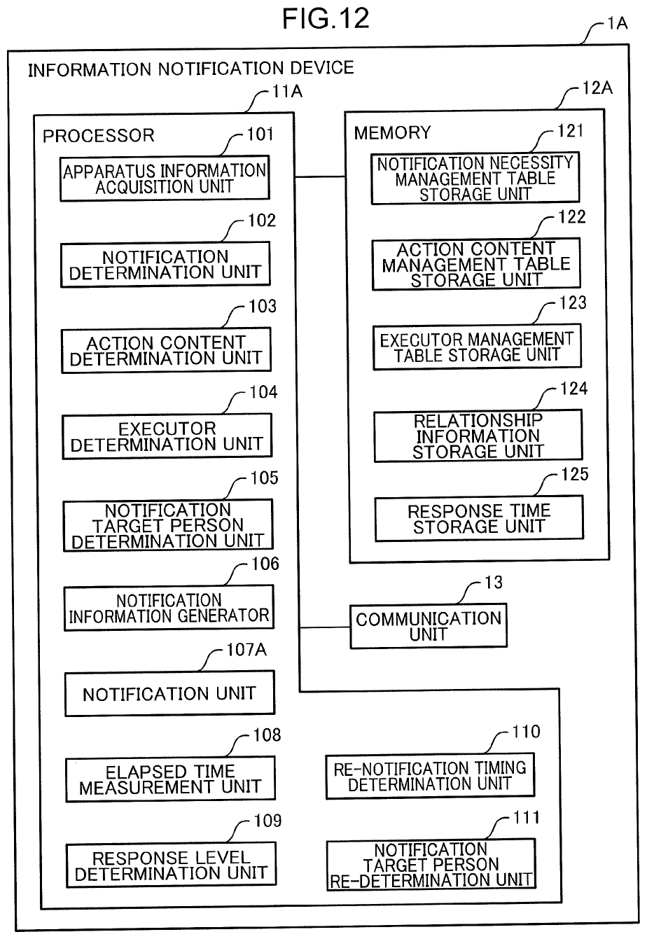

FIG. 12 is a diagram illustrating an example of a configuration of an information notification device 1A according to the second embodiment of the present disclosure.

The information notification device 1A illustrated in FIG. 12 includes a processor 11A, a memory 12A, and the communication unit 13. In the second embodiment, the same components as those in the first embodiment are denoted by the same reference signs, and will not be described.

The processor 11A implements the apparatus information acquisition unit 101, the notification determination unit 102, the action content determination unit 103, the executor determination unit 104, the notification target person determination unit 105, the notification information generator 106, a notification unit 107A, an elapsed time measurement unit 108, a response level determination unit 109, a re-notification timing determination unit 110, and a notification target person re-determination unit 111.

The memory 12A implements the notification necessity management table storage unit 121, the action content management table storage unit 122, the executor management table storage unit 123, the relationship information storage unit 124, and a response time storage unit 125.

When an action is performed on an apparatus, the communication unit 13 acquires execution completion information indicating that the action is performed on the apparatus. The communication unit 13 receives the execution completion information transmitted by the apparatus. When the action on the apparatus is performed, the apparatus transmits the execution completion information to the information notification device 1.

The elapsed time measurement unit 108 measures an elapsed time from notification of the notification information. When the notification information is notified, the elapsed time measurement unit 108 starts measuring the elapsed time. When the execution completion information indicating that the action is performed on the apparatus is acquired, the elapsed time measurement unit 108 ends the measurement of the elapsed time. Then, the elapsed time measurement unit 108 measures a response time from when the notification information is notified until the executor performs the action on the apparatus, and stores the response time in the response time storage unit 125.

The response time storage unit 125 stores the response time from when the notification information is notified until the executor performs the action on the apparatus.

The response level determination unit 109 determines a response level of the executor. The response level determination unit 109 determines the response level of the executor in accordance with the response time from when the notification information is notified to the notification target person until the executor performs the action on the apparatus. As the response time is shorter, the response level is higher, and as the response time is longer, the response level is lower.

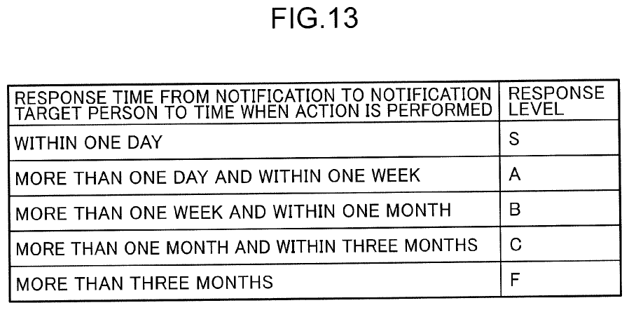

FIG. 13 is a diagram illustrating an example of a response rule in which response time from notification to the notification target person to time when the action is performed is associated with a response level according to the second embodiment.

As illustrated in FIG. 13, a response time within one day has a response level “S” that is the highest, a response time more than one day and within one week has a response level “A” that is the second highest, a response time more than one week and within one month has a response level “B” that is the third highest, a response time more than one month and within three months has a response level “C” that is the fourth highest, and a response time more than three months has a response level “F” that is the lowest.

The response level determination unit 109 determines the response level of the executor in accordance with a previous latest response time of the executor. When the executor is first determined, the response level determination unit 109 determines the lowest response level “F” as the response level of the executor.

The response level determination unit 109 may also determine an average value of multiple response levels corresponding to respective multiple previous response times of the executor as the response level of the executor. For example, the response level “S” has four points, the response level “A” has three points, the response level “B” has two points, the response level “C” has one point, and the response level “F” has zero point. When the response levels “B”, “A”, “B”, and “S” correspond to response times of previous four times, the four response levels have an average value of 2.75 of the points, and have a rounded average value of 3 of the points. Thus, the response level of the executor is determined to be “A”.

The re-notification timing determination unit 110 determines re-notification timing at which the notification information is notified again. Examples of the re-notification timing include a time point when one week elapsed from first notification, a time point when one month elapsed from the first notification, and a time point when three months elapsed from the first notification. The re-notification timing determination unit 110 determines the time point when one week elapsed from the first notification as the re-notification timing. Then, when the execution completion information is not acquired even when one week elapsed from the first notification, the re-notification timing determination unit 110 determines the time point when one month elapsed from the first notification as the re-notification timing. Then, when the execution completion information is not acquired even when one month elapsed from the first notification, the re-notification timing determination unit 110 determines the time point when three months elapsed from the first notification as the re-notification timing.

Although the re-notification timing in the second embodiment is determined in advance, the present disclosure is not particularly limited thereto. The re-notification timing determination unit 110 may determine the re-notification timing in accordance with a response level of a user being the executor. For example, when the user being the executor has the lowest response level “F”, the re-notification timing determination unit 110 may determine a time point when two days elapsed from the first notification as the re-notification timing. As described above, the re-notification timing determination unit 110 may shorten a period from the first notification to second notification as the response level of the executor becomes lower.

The notification target person re-determination unit 111 determines whether elapsed time measured by the elapsed time measurement unit 108 has reached the re-notification timing determined by the re-notification timing determination unit 110.

When the execution completion information is not acquired even when a predetermined time elapsed after the notification information is notified, the notification target person re-determination unit 111 re-determines the notification target person in accordance with the previous response time of the executor. At this time, when determining that the elapsed time from the first notification of the notification information has reached the re-notification timing, the notification target person re-determination unit 111 re-determines the notification target person in accordance with the response level and the re-notification timing.

The notification unit 107A notifies the notification target person re-determined by the notification target person re-determination unit 111 of the notification information again. The notification unit 107A transmits the notification information generated by the notification information generator 106 to a mobile terminal held by the notification target person re-determined by the notification target person re-determination unit 111 via the communication unit 13.

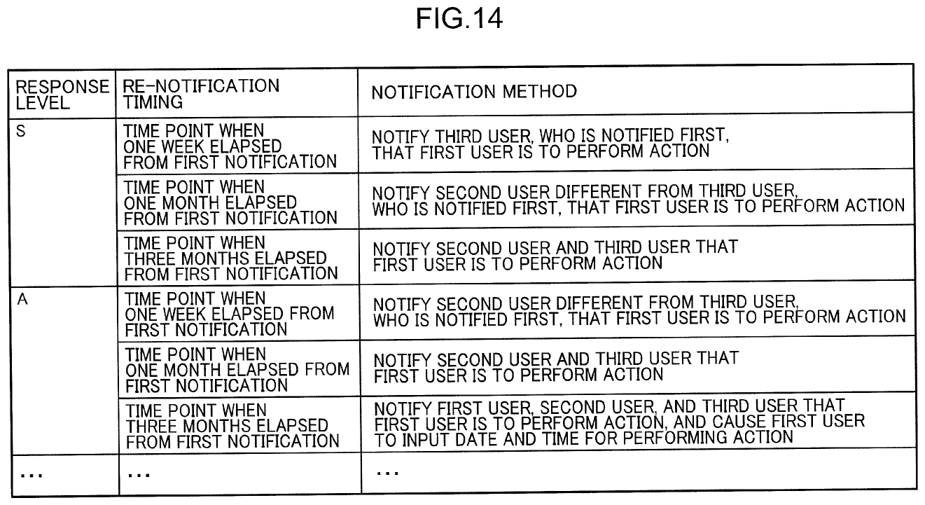

FIG. 14 is a diagram illustrating an example of a notification method determined based on the response level illustrated in FIG. 13.

As illustrated in FIG. 14, when the first user is the executor and has the highest response level “S”, and the re-notification timing is a time point when one week elapsed from the first notification, the notification target person re-determination unit 111 re-determines the third user same as that in the first notification as the notification target person. Then, the information notification device 1 notifies the third user that the first user is to perform the action. When the first user is the executor and has the highest response level “S”, and the re-notification timing is a time point when one month elapsed from the first notification, the notification target person re-determination unit 111 re-determines the second user different from the third user determined in the first notification as the notification target person. Then, the information notification device 1 notifies the second user that the first user is to perform the action. When the first user is the executor and has the highest response level “S”, and the re-notification timing is a time point when three months elapsed from the first notification, the notification target person re-determination unit 111 re-determines each of the second user and the third user as the notification target person. Then, the information notification device 1 notifies the second user and the third user that the first user is to perform the action.

When the first user is the executor and has the second highest response level “A”, and the re-notification timing is a time point when one week elapsed from the first notification, the notification target person re-determination unit 111 re-determines the second user different from the third user determined in the first notification as the notification target person. Then, the information notification device 1 notifies the second user that the first user is to perform the action. When the first user is the executor and has the second highest response level “A”, and the re-notification timing is a time point when one month elapsed from the first notification, the notification target person re-determination unit 111 re-determines each of the second user and the third user as the notification target person. Then, the information notification device 1 notifies the second user and the third user that the first user is to perform the action. When the first user is the executor and has the second highest response level “A”, and the re-notification timing is a time point when three months elapsed from the first notification, the notification target person re-determination unit 111 re-determines each of the first user, the second user, and the third user as the notification target person. Then, the information notification device 1 notifies the first user, the second user, and the third user that the first user is to perform the action, and further causes the first user to input a date and time for performing the action.

Subsequently, information notification processing with the information notification device 1A according to the second embodiment of the present disclosure will be described.

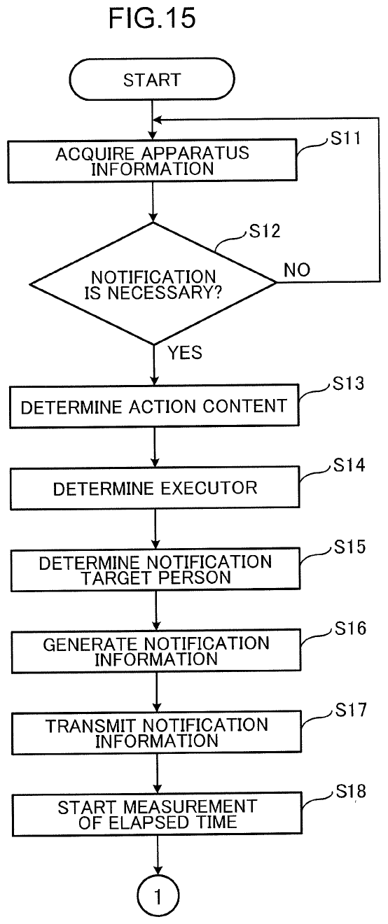

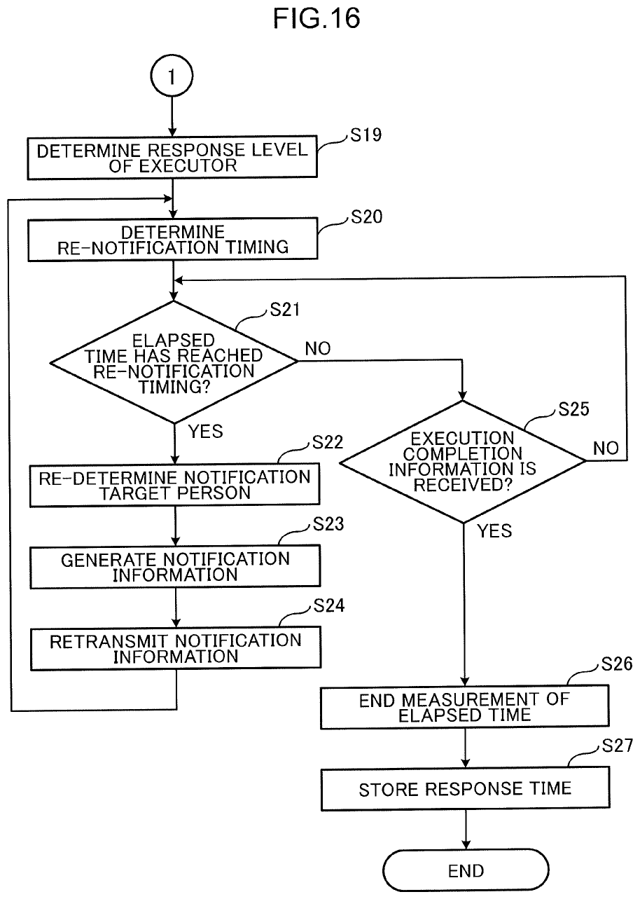

FIG. 15 is a first flowchart for illustrating the information notification processing with the information notification device 1A according to the second embodiment of the present disclosure, and FIG. 16 is a second flowchart for illustrating the information notification processing with the information notification device 1A according to the second embodiment of the present disclosure.

Processing in steps S11 to S17 illustrated in FIG. 15 is the same as the processing in steps S1 to S7 illustrated in FIG. 9, and thus will not be described.

In subsequent step S18, the elapsed time measurement unit 108 starts measuring elapsed time after the notification information is transmitted to the mobile terminal.

In subsequent step S19, the response level determination unit 109 determines a response level of the executor in accordance with previous response time of the executor stored in the response time storage unit 125.

In subsequent step S20, the re-notification timing determination unit 110 determines re-notification timing at which the notification information is notified again. At this time, the re-notification timing determination unit 110 determines a time point when one week elapsed from the first notification as the re-notification timing.

In subsequent step S21, the notification target person re-determination unit 111 determines whether elapsed time measured by the elapsed time measurement unit 108 has reached the re-notification timing determined by the re-notification timing determination unit 110.

Here, when it is determined that the elapsed time has reached the re-notification timing (YES in step S21), the notification target person re-determination unit 111 re-determines the notification target person in accordance with the response level and the re-notification timing.

In subsequent step S23, the notification information generator 106 generates notification information indicating that the executor is to perform the action.

In subsequent step S24, the notification unit 107A retransmits the notification information generated by the notification information generator 106 to a mobile terminal held by the notification target person re-determined by the notification target person re-determination unit 111 via the communication unit 13. After that, the processing returns to step S20, and the re-notification timing determination unit 110 determines the re-notification timing having a longer period than that for the previous notification. At this time, the re-notification timing determination unit 110 determines a time point when one month elapsed from the first notification as the re-notification timing.

In contrast, when it is determined that the elapsed time has not reached the re-notification timing (NO in step S21), the elapsed time measurement unit 108 determines whether the communication unit 13 receives execution completion information indicating that the executor performs the action on the apparatus, in step S25. Here, when it is determined that the execution completion information has not been received (NO in step S25), the processing returns to step S21.

In contrast, when it is determined that the execution completion information has been received (YES in step S25), the elapsed time measurement unit 108 ends the measurement of the elapsed time after the notification information is transmitted to the mobile terminal, in step S26.

In subsequent step S27, the elapsed time measurement unit 108 stores a response time from when the notification information is notified until the executor performs the action on the apparatus in the response time storage unit 125.

As described above, when the response time from when the notification information is notified until the executor performs the action on the apparatus 2 is measured, and the execution completion information is not acquired even when the predetermined time elapsed after the notification information is notified, the notification target person is re-determined in accordance with the previous response time of the executor. For example, when the previous response time is shorter than the predetermined time, the user who is notified of the notification information first is re-determined as the notification target person, and when the previous response time is equal to or longer than the predetermined time, a user different from the user who is notified of the notification information first is redetermined as the notification target person. This configuration enables the user, different from the user who is notified of the notification information first, to prompt the executor, whose previous response time is relatively long, to perform the action on the apparatus 2.

In each of the above embodiments, each component may be configured by dedicated hardware, or may be implemented by executing a software program suitable for each component. Each component may be implemented by a program execution unit such as a CPU or a processor reading and executing a software program recorded on a recording medium such as a hard disk or a semiconductor memory. Alternatively, the program may be executed by another independent computer system by recording and transferring the program on a recording medium or transferring the program via a network.

Some or all of the functions of the devices according to the embodiments of the present disclosure are implemented as large scale integration (LSI), which is typically an integrated circuit. These may be individually integrated into one chip, or may be integrated into one chip including some or all of the functions. The integrated circuit is not limited to the LSI, and may be implemented by a dedicated circuit or a general purpose processor. Available examples include a field programmable gate array (FPGA) that can be programmed after manufacturing of LSI, and a reconfigurable processor in which connections and settings of circuit cells inside LSI can be reconfigured.

Some or all of the functions of the devices according to the embodiments of the present disclosure may be implemented by executing a program with a processor such as a CPU.

The numbers used above are merely examples for specifically describing the present disclosure, and the present disclosure is not limited to the illustrated numbers.

The order in which each step illustrated in the above flowchart is performed is for specifically describing the present disclosure, and may be an order other than the above order as long as a similar effect can be obtained. Some of the above steps may be performed simultaneously (concurrently) with another step.

The technique according to the present disclosure enables an executor to reliably perform an action on an apparatus, and thus is useful as a technique for determining a user to be notified of information from among multiple users and notifying the determined user of the information.

1. An information notification method comprising, by a computer:
acquiring apparatus information on an apparatus;
determining an action for the apparatus based on the apparatus information;
determining an executor who is to perform the determined action from among multiple users;
determining a notification target person to be notified that the executor is to perform the action with reference to relationship information indicating a relationship among the multiple users; and
notifying the determined notification target person of notification information indicating that the executor is to perform the action.

2. The information notification method according to claim 1, wherein
the notification target person is a user different from the executor, and
the notification information includes information prompting the notification target person to notify the executor that the executor is to perform the action.

3. The information notification method according to claim 1, wherein the notification target person is the same user as the executor.

4. The information notification method according to claim 1, wherein
the relationship information includes table information in which each of the multiple users is associated with a priority for corresponding one of the multiple users, and
in determining the notification target person, a user having a highest priority and being associated with the executor is determined as the notification target person with reference to the relationship information.

5. The information notification method according to claim 4, wherein
in determining the notification target person, when a user having a highest priority and being associated with the executor belongs to a layer group to which the executor belongs, with reference to layer information indicating that each of the multiple users belongs to which one of multiple hierarchical layer groups and the relationship information, the user having the highest priority and the executor are each determined as the notification target person, and
when the user having the highest priority associated with the executor belongs to a layer group to which the executor does not belong, only the user having the highest priority is determined as the notification target person.

6. The information notification method according to claim 1, further comprising:
acquiring execution completion information indicating that the action is performed on the apparatus when the action is performed on the apparatus;
determining each of the multiple users or a user other than the user who is notified of the notification information first among the multiple users as the notification target person, when the execution completion information is not acquired even when a predetermined time elapsed after the notification information is notified; and
notifying the determined notification target person of the notification information again.

7. The information notification method according to claim 6, further comprising restricting use of the apparatus when the execution completion information is not acquired even when a predetermined time elapsed after the notification information is notified again.

8. The information notification method according to claim 1, further comprising:
measuring a response time from when the notification information is notified until the executor performs the action on the apparatus to store the response time in a memory;
acquiring execution completion information indicating that the action is performed on the apparatus when the action is performed on the apparatus;
re-determining the notification target person in accordance with previous response time of the executor when the execution completion information is not acquired even when a predetermined time elapsed after the notification information is notified; and
notifying the notification information again to the re-determined notification target person.

9. The information notification method according to claim 1, wherein the apparatus information includes information on an error that has occurred in the apparatus, information on maintenance of the apparatus, or information indicating a predetermined function of the apparatus, selected by a user.

10. The information notification method according to claim 1, wherein in notifying the notification information, the notification information is transmitted to a terminal held by the notification target person.

11. The information notification method according to claim 1, wherein in notifying the notification information, the notification information is transmitted to an apparatus that is used most frequently by the notification target person with reference to use history information indicating use history of multiple apparatuses of the respective multiple users.

12. The information notification method according to claim 1, wherein in notifying the notification information, when the executor is the notification target person, a time period in which the notification target person uses the apparatus on which the action is performed is identified with reference to the use history information indicating use history of multiple apparatuses of the respective multiple users, and the notification information is transmitted to an apparatus to be used by the notification target person by a predetermined time before the identified time period.

13. The information notification method according to claim 1, wherein in notifying the notification information, a series of actions in which the notification target person uses the respective multiple apparatuses is grouped and arranged in time series with reference to the use history information indicating use history of the multiple apparatuses of the respective multiple users, a group is identified in which the notification target person uses the apparatus on which the action is to be performed, and the notification information is transmitted to an apparatus used in a last action of a group immediately before the identified group, an apparatus used in a first action of the identified group, or an apparatus used in a last action of the identified group.

14. An information notification device comprising:
an acquisition unit configured to acquire apparatus information on an apparatus;
an action determination unit configured to determine an action for the apparatus based on the apparatus information;
an executor determination unit configured to determine an executor who is to perform the determined action from among multiple users;
a notification target person determination unit configured to determine a notification target person to be notified that the executor is to perform the action with reference to relationship information indicating a relationship among the multiple users; and
a notification unit configured to notify the determined notification target person of notification information indicating that the executor is to perform the action.

15. A non-transitory computer readable recording medium storing an information notification program that causes a computer to perform functions of:
acquiring apparatus information on an apparatus;
determining an action for the apparatus based on the apparatus information;
determining an executor who is to perform the determined action from among multiple users;
determining a notification target person to be notified that the executor is to perform the action with reference to relationship information indicating a relationship among the multiple users; and
notifying the determined notification target person of notification information indicating that the executor is to perform the action.
